(19) United States
(12) Patent Application Publication
(10) Pub. No.: US 2004/0058260 A1
(43) Pub. Date: Mar. 25, 2004

(54) Toner composition, two component developer using the toner composition, and method and apparatus for developing electrostatic latent image using the toner composition

(76) Inventors: Kohichi Katoh, Yokohama-shi (JP); Masahiko Ishikawa, Fuji-shi (JP); Yohta Sakon, Numazu-shi (JP); Tomoyuki Ichikawa, Numazu-shi (JP); Hiroshi Nakai, Yokohama-shi (JP); Kazuhiko Umemura, Suntoh-gun (JP); Minoru Masuda, Numazu-shi (JP); Hideki Sugiura, Fuji-shi (JP); Kazumi Suzuki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/609,399

(22) Filed: Jul. 1, 2003

(30) Foreign Application Priority Data
Jul. 3, 2002 (JP) 2002-194582

(51) Int. Cl. G03G 9/097

(52) U.S. Cl. 430/108.3; 430/120; 399/258; 430/108.7

(57) ABSTRACT

A toner composition including toner particles; and an external additive located on the surface of the toner particles and including Si, wherein the toner composition satisfies the following relationship, (PSi2p (1 min)−PSi2p (30 min))≦0.8 eV, wherein PSi2p (1 min) and PSi2p (30 min) represent positions of the Si2p peaks of the Si element of the toner composition when the toner composition is subjected to an X-ray photoelectron spectroscopy analysis after the toner composition is mixed with a carrier for 1 minute or 30 minutes using a TURBULA mixer at a revolution of 20 rpm, respectively.

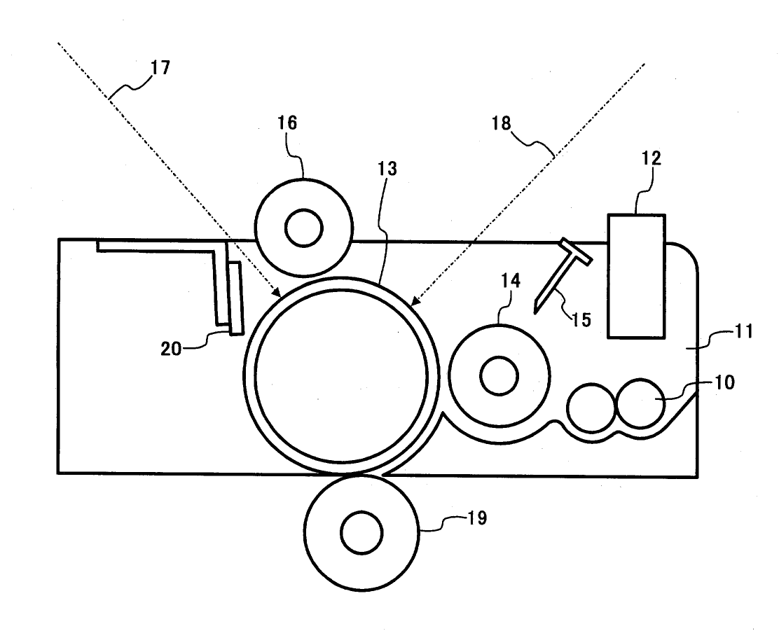

### BACKGROUND OF THE INVENTION

1. Field of the Invention

The present invention relates to a toner composition for developing an electrostatic latent image formed by electrophotography, electrostatic recording and electrostatic printing. In addition, the present invention relates to a two component developer using the toner composition, and a method and apparatus for developing an electrostatic latent image using the toner composition.

2. Discussion of the Background

With development of information technology (IT technology) as a worldwide important technology, personal computers (PCs) have been widely used so that every person in offices uses a PC. A document prepared by a PC is distributed as electronic data to the relevant people. Alternatively, the document is output on a receiving material such as papers by an image forming apparatus such as printers or copiers to be distributed to the relevant people.

In such offices, network type electronic data outputting apparatus such as printers and copiers are typically used so that electronic data prepared by or stored in every PC can be output. Electrophotographic image forming apparatus are typically used as such network type electronic data outputting apparatus. When electrophotographic image forming apparatus are used, waste toner (waste developer) is typically produced.

Electrophotographic image forming apparatus typically use a two component developer including a carrier and a toner. Since a carrier charges a toner, which is used for developing an electrostatic latent image, while rubbing the toner, the carrier has a life. Therefore, it is necessary to dispose of or recycle such a carrier. It is preferable to recycle a carrier in view of environmental protection. However, it causes an environmental problem if a carrier is disposed of.

In order to protect environment, various activities have been performed by many countries and companies. For examples the following activities are performed:

(1) recycling materials;

(2) using materials which do not cause environmental pollution or hardly cause environmental pollution;

(3) zero emission;

(4) saving energy;

(5) preventing the earth from warming; and

(6) using clean energy.

Against such background, a need exists for an electronic data outputting apparatus which is environmentally friendly.

One component developing methods which use a developer including no carrier have been proposed. However, a large amount of developer (i.e., toner) remains on a surface of an image bearing member even after a toner image is transferred onto a receiving material (the same is true for two component developers). Therefore the methods are not environmentally friendly. In addition, the methods are not suitable for high speed recording.

Therefore a need exists for an electronic data outputting apparatus which are environmentally friendly and which can output electronic data as a hard copy.

Recently, not only high speed monochrome image forming apparatus but also high speed full color image forming apparatus are needed. However, both monochrome images and full color images are produced in full color image forming apparatus. Therefore, hard copies having various image occupying rates (i.e., a ratio of the image area in a hard copy to the total area of the hard copy) are produced. For example, the image occupying rate is about 7% for documents including normal character images. In contrast, documents used for presentation purpose, which typically include photographs or pictures, often have an image occupying rate not less than 80% This means that the amount of toner consumed is largely different depending on the images to be output. Namely, a different amount of toner has to be supplied to a developing unit depending on the images to be output. Since the amount of carrier is constant in a developing unit, the carrier has to stably impart a certain amount of charge to the toner even when the amount of toner supplied to the developing unit is different.

However, conventional two component developers cannot fulfill such a requirement. The reason therefor is that the properties of the carriers of two component developers and the surface conditions of the toners therein change with time. Thus, the carriers have a short life, resulting in production of a large amount of waste carriers. Namely, it is not environmentally friendly.

One of the reasons for the deterioration of the charging properties of a newly supplied toner (a replenished toner) is that the properties of the toner (hereinafter previously existing toner) present in a developing unit are different from those of the replenished toner. Since the previously existing toner is mixed with a carrier in a developing unit and in addition is passed through between a developing sleeve and a doctor blade or a doctor roller, the previously existing toner receives external stresses. When a toner receives an external stress, the surface conditions of the toner (i.e., the conditions of an external additive present on the surface of the toner) change or the form of the toner particles greatly changes. When the charge properties of the toner largely depend on the charge properties of the additive, the charge quantity of the toner changes if the conditions of the additive change.

In addition, when replenishing such a changed toner with new one of the toner, proper charging properties cannot be imparted to the newly added toner. In addition, there is a case in which the charge properties of the previously existing toner are often deteriorated when a new toner is added.

Another reason for shortening of life of a carrier is that constituents of the toner used adhere to the carrier and thereby the charging ability of the carrier is deteriorated. Namely, toner constituents such as external additives present on the surface of the toner, e.g., silica, titania and zinc stearate, and constituents constituting the mother toner particles, e.g., resins, waxes and charge controlling agents, adhere to the carrier.

Published unexamined Patent Application No. (hereinafter JOP) 9-274368 discloses a toner replenishing device including the following members:

(1) a toner container having a cylindrical form and an oval opening which is formed on a center of an end of the container and from which the toner contained in the container is discharged;

(2) a container supporting member having an opening, through which the toner discharged from the oval opening is fed to a developing device, and supporting the toner container so as to be substantially horizontally positioned;

(3) a container holding member having plural ribs on which an extruder which integrally rotates with the toner container and feeds the toner discharged from the oval opening to the opening is provided; and

(4) a rotation driving device which rotates the toner container supported by the container supporting member around the longitudinal axis of the toner container.

The toner replenishing device is characterized in that the toner is discharged from both end portions of the oval opening in the longitudinal direction of the oval opening; and the plural ribs are arranged such that the end portions of the oval opening are located at an intermediate position between adjacent two ribs of the plural ribs. It is described therein that a certain amount of toner can be stably replenished to a developing section. However, it is not described whether occurrence of the problem in that the toner constituents adhere to the carrier can be prevented.

In addition, JOP 2000-267354 discloses a technique such that an additive is mixed with toner particles at a temperature higher than room temperature to fix the additive on the surface of the toner particles. By using this technique, the additives can be fixed on the toner particles to some extent, but it is impossible to fix all the particles of the additive on the toner particles in the same manner.

Further, JOP 2000-267333 discloses a technique such that an additive is fixed to toner particles using ultrasound. Even when this technique is used, it is also impossible to fix all the particles of the additive on the toner particles in the same manner. Namely, it is difficult to prevent the toner constituents from adhering to the carrier.

JOP 7-92727 discloses a technique such that an additive is embedded to toner particles. However, the conditions of the additive embedded to the toner particles are not necessarily uniform, and therefore it is hard to impart good durability to the resultant toners.

JOP 10-221937 discloses a developing method in which a developer is fed to a developer bearing member, which faces an image bearing member having an electrostatic latent image thereon, while the developer is agitated by an agitating screw. In this developing method, the agitating screw includes a spiral blade having a trapeziform cross section and a rotating shaft. In this method, the angle θ1 formed by the slant face of the spiral blade on a side facing in the developing carrying direction of the spiral blade and the rotation center axis is set larger than an angle θ2 formed by a slant face on a side facing in a direction opposite to the developer carrying direction. Thus, the developer is fed to the developer bearing member while agitated.

According to this technique, the charging properties of a replenished toner can be improved when a specific combination of a toner and a carrier is used. However, this technique cannot be applied to all combinations of a toner and a carrier. In particular, when an additive is present in toner particles while having an undesired condition (for example, when the additive is embedded to the toner particles), it is difficult to impart good charge properties to the toner particles.

Because of these reasons, a need exists for a toner which has good charge properties and good durability without contaminating the carrier used together with the toner and which can produce good images without causing a background fouling problem and a toner scattering problem.

### SUMMARY OF THE INVENTION

Accordingly, an object of the present invention is to provide a toner which has good charge properties and good durability without contaminating the carrier used together with the toner and which can produce good images without causing a background fouling problem and a toner scattering problem.

Another object of the present invention is to provide a developer which can produce good images without causing a background fouling problem and a toner scattering problem.

Yet another object of the present invention is to provide a method and an apparatus for developing an electrostatic latent image which can produce good images without causing a background fouling problem and a toner scattering problem.

Briefly these objects and other objects of the present invention as hereinafter will become more readily apparent can be attained by a toner composition including toner particles and an inorganic or organic additive (i.e., an external additive) located on the surface of the toner particles and including Si, wherein the toner satisfies the following relationship:

(PSi2p(1 min)−PSi2p (30 min))≦0.8 eV

wherein PSi2p (1 min) represents the position of the Si2p peak of the Si element of the toner composition when the toner composition is subjected to an X-ray photoelectron spectroscopy analysis after the toner composition is mixed with a carrier for 1 minute using a TURBULA mixer at a revolution of 20 rpm, and PSi2p (30 min) represents the position of Si2p peak of the Si element of the toner composition when the toner composition is mixed with the carrier for 30 minute using a TURBULA mixer.

It is preferable that the half width of the Si2p peak of the Si element at the position PSi2p (30 min) is not less than 1.20 times the half width of the Si2p peak of the Si element at the position PSi2p (1 min).

It is preferable that the electrons are shared by the additive and the toner particles.

It is preferable that when the toner is used for a developing device which includes a mixing section having a two-axis screw and configured to mix the carrier and the toner, a toner replenishing section configured to replenish the toner to the mixing section, a developing sleeve configured to bear the toner on the surface thereof to adhere the toner to an electrostatic latent image on an image bearer, and a regulating member such as doctor blades and doctor rollers configured to regulate flow of the toner to the developing sleeve, the replenished toner has substantially the same charge quantity as that of the toner, which previously exists in the mixing section and fed together with the replenished toner, before the replenished toner and the previously existing toner reach the regulating member.

It is preferable that the replenished toner has a charge quantity not less than 0.7 times that of the previously existing toner before the replenished toner and the previously existing toner reach the regulating member.

Another aspect of the present invention, a two component developer is provided which includes the toner of the present invention mentioned above and a carrier.

It is preferable that the carrier is coated with a material such that any portions of the coated material have a thickness in a range of from 75% to 125% of the average thickness.

Yet another aspect of the present invention, a method for developing an electrostatic latent image is provided which includes:

replenishing a toner from a replenishing section;

mixing a carrier and the toner in a mixing section having a two-axis screw to prepare a developer,

feeding the developer toward a developing sleeve;

regulating flow of the developer to the developing sleeve with a regulating member such as doctor blades and doctor rollers; and

developing the electrostatic latent image with the toner in the developer on the developing sleeve,

wherein the toner is the toner composition of the present invention.

These and other objects, features and advantages of the present invention will become apparent upon consideration of the following description of the preferred embodiments of the present invention taken in conjunction with the accompanying drawing.

### BRIEF DESCRIPTION OF THE DRAWING

Various other objects, features and attendant advantages of the present invention will be more fully appreciated as the same becomes better understood from the detailed description when considered in connection with the accompanying drawing in which like reference characters designate like corresponding parts throughout and wherein:

FIGURE is a schematic view illustrating a developing unit for which the toner of the present invention can be used.

### DETAILED DESCRIPTION OF THE INVENTION

The two component developer of the present invention is characterized in that when the developer is agitated using a TUBULA mixer, the following relationship is satisfied:

(PSi2p (1 min)−PSi2p (30 min))≦0.8 eV

wherein PSi2p (1 min) represents the position of the peak of Si2p (i.e., the 2p orbit of a Si element) of the surface of the toner composition detected by X-ray photoelectron spectroscopy when the developer is agitated for 1 minute, and PSi2p (30 min) represents the position of Si2p of the surface of the toner composition when the developer is agitated for 30 minute.

The X-ray photoelectron spectroscopy is as follows. By irradiating a material with an X-ray, an electron present in an inner orbit of the material is emitted therefrom. By measuring the energy of the emitted electron, the state of the material can be determined. Molecules of a material freely move at room temperature. In addition, since a material has multiple states (i.e., multiple energy levels), the resultant X-ray photoelectron spectroscopy spectrum of the material has a broad peak, which is typically represented as a Gaussian curve. In the present application, the peak means the peak of the Gaussian curve having units of electron volt (eV). In addition, the Si2p represents the 2p orbit of a Si element, and the peak of Si2p represents a top of a Gaussian curve of energies of the electrons emitted from the Si2p orbit of a Si element.

“TURBULA mixer” means a commercially available mixer, TURBULA SHAKER MIXER T2F-10B-50A, manufactured by Willy A. Bachofen AG. In this case, the agitation is performed at a revolution of 20 rpm.

The toner of the present invention, which can satisfy the relationship, can be manufactured, for example, by the following method.

The toner composition of the present invention typically includes toner particles including a binder resin, a colorant, a wax, and internal additives such as charge controlling agents, and dispersants, and an external additive which includes an inorganic or organic material including a Si element and which is present on the surface of the toner particles. As the binder resin, resins having a high charging ability such as polyester resins are preferably used. In the toner of the present invention, polyol resins and epoxy resins are not preferable as the binder resin.

At first, a binder resin (a polyester resin), a colorant, a wax, and additives such as colorant, dispersants and wax dispersants, which are added if desired, are kneaded. Known materials can be used as the toner constituents, but materials having high crystallinity are preferably used as the dispersants rather than amorphous materials.

When the kneading is performed, the materials are preferably cooled for about 1 hour at a temperature of −20° C., and then kneaded using a two-axis screw kneader. In addition, it is preferable that the kneaded mixture is continuously extruded by a die without causing pulsating flow. When the kneading is performed while causing pulsating flow, problems such that the mixture is undesirably dispersed; and the external additive and the surface of the resultant toner share an undesired electronic state.

Then the kneaded mixture is pulverized and classified by a jet pulverizer, resulting in formation of toner particles. The toner particles are then mixed with an external additive, i.e., an inorganic or organic material including Si, followed by sieving. Thus, a toner composition of the present invention can be prepared.

When the external additive is mixed with the toner particles, at first they are mixed so as to achieve an ordered mixture state in which the external additive is uniformly adhered on the surface of the toner particles, and then energy is applied thereto to mix them. The mixing energy is preferably controlled such that the external additive collides the toner particles at a speed such that the binder resin of the toner particles has a temperature not less than the phase transition temperature thereof.

Suitable materials for use as the inorganic or organic materials including Si include inorganic materials such as particulate silica which is manufactured by a wet or dry manufacturing method, and organic materials such as powders of fluorine-containing resins, e.g., vinylidene fluoride resins and polytetrafluoroethylene resins, and materials which are prepared by subjecting a powder such as silica, titanium oxide and alumina to a surface treatment using an agent such as silane coupling agents and silicone oils. The content of the external additive (i.e., inorganic or organic materials including Si) in the toner composition is preferably from 0.1 to 10.0% by weight based on the weight of the toner particles. As the external additive, materials not including Si can be used in combination with the inorganic or organic materials including Si.

According to the present invention, it is preferable that the half width of the peak of Si2p at the position PSi2p (30 min) is not less than 1.20 times the half width of the peak of Si2p at the position PSi2p (1 min). When the half widths of the peaks satisfy the condition, the charge properties of the toner of the present invention can be further enhanced (i.e., the toner can exhibit excellent performance when used as a replenished toner).

In addition, it is preferable that the electrons are shared by the external additive and the toner particles. At this point, “electron sharing” means that a portion of the external additive having a volume of about 50% of the total volume of the external additive is embedded into and fixed to the surface portion of the toner particles. By such electron sharing is performed, deterioration of the charge properties of the toner composition can be minimized even if the external additive is further embedded into the toner particles or the external additive is covered with any other materials when the toner composition is used.

Then the developing unit for use in the present invention will be explained. Any known developing units can be used in the present invention. FIGURE illustrates a developing unit for which the toner of the present invention can be used.

In FIGURE, the developing unit includes a mixing section 11 having a two-axis screw 10 configured to mix the toner of the present invention and a carrier, a toner replenishing section 12 configured to replenish the toner (new one of the toner), a developing sleeve 14 configured to adhere the toner to an electrostatic latent image formed on a photoreceptor 13, and a doctor blade 15 configured to regulate the flow of the toner toward the developing sleeve 14. The doctor blade 15 can be replaced with a doctor roller.

In FIGURE, numeral 16 denotes a charger (a charging roller) which contacts the photoreceptor 13 or is arranged closely to the photoreceptor 13 while a small gap is formed to uniformly charge the photoreceptor 13. Numerals 17 and 18 denote discharge light which is used to discharge the photoreceptor 13, and imagewise laser light which is emitted by a light irradiator (not shown) to form an electrostatic latent image on the surface of the photoreceptor 13, respectively. Numerals 19 and 20 denote a transfer roller configured to transfer the toner image on the photoreceptor 13 to a receiving material, and a cleaning blade configured to remove toner particles remaining on the surface of the photoreceptor 13 even after the toner image is transferred.

According to the present invention, when the toner (replenished toner) of the present invention and a carrier are added from the toner replenishing section 12 and mixed with the two-axis screw 10, the replenished toner has a charge quantity which is almost the same as that of toner (the toner previously existing in the mixing section 11) before the replenished toner reaches the doctor blade (or doctor roller) 15. At this point, the term “substantially the same” means 70% or more of the charge quantity of the previously existing toner. Since the toner of the present invention has such a charge property, images having good image qualities can be produced without causing background fouling.

In the present invention, a two-component developer including the toner of the present invention and a carrier is also provided. The carrier for use in the present invention is not particularly limited, but materials such as iron powders, ferrite powders, magnetite powders and magnetic resin powders, which have a particle diameter of from 20 to 200 μμm, can be preferably used. It is preferable to mix the toner with a carrier in a weight ratio of from 1/100 to 10/100.

The carrier is preferably coated with a coating material. In addition, it is preferable that any portions of the material coated on the surface of the carrier have a thickness in a range of from 75% to 125% of the average thickness thereof, to prevent occurrence of background fouling.

Suitable materials for use as the coating material include straight silicone resins, such as KR271, KR272, KR282, KR252 and KR152, which are manufactured by Shin-Etsu Chemical Co., Ltd.; and SR2400 and SR2406, which are manufactured by Dow Corning Toray Silicone Co., Ltd. In addition, modified silicone resins can also be used as the coating material. Specific examples of the modified silicone resins include epoxy-modified silicone resins (e.g., ES-1001N from Shin-Etsu Chemical Co., Ltd., and SR2115 from Dow Corning Toray Silicone Co., Ltd.); acrylic-modified silicone resins (e.g., KR5208 from Shin-Etsu Chemical Co., Ltd.); phenolic-modified silicone resins; urethane-modified silicone resins (e.g., KR305 from Shin-Etsu Chemical Co., Ltd.); polyester-modified silicone resins (e.g., KR5203 from Shin-Etsu Chemical Co., Ltd.); and alkyd-modified silicone resins (e.g., KR-206 from Shin-Etsu Chemical Co., Ltd., and SR2110 from Dow Corning Toray Silicone Co., Ltd.).

In addition, an amino silane coupling agent can be mixed with the silicone resins mentioned above in an amount of from 0.001 to 20% by weight. Specific examples of the amino silane coupling agents include H₂N(CH₂)₃Si(OCH₃)₃, H₂N(CH₂)₃Si(OC₂H₅)₃, H₂N(CH₂)₃Si(CH₃)₂OC₂H₅, H₂N(CH₂)₃Si(CH₃) (OC₂H5)₂, H₂NCH₂CH₂NHCH₂Si(OCH₃)₃, H₂NCH₂CH₂NHCH₂CH₂CH₂Si(CH₃)(OCH₃)₂, H₂NCH₂CH₂NHCH₂CH₂Si(OCH₃) 3, (CH₃)₂NCH₂CH₂CH₂Si (CH₃)(OC₂H₅) 2, and (C₄H₉)₂NC₃H₆Si(OCH₃)₃.

Other resins can be mixed with the silicone resins. Specific examples of such resins include styrene resins such as polystyrene, chloropolystyrene, poly-α-methyl styrene, styrene-chlorostyrene copolymers, styrene-propylene copolymers, styrene-butadiene copolymers, styrene-vinyl chloride copolymers, styrene-vinyl acetate copolymers, styrene-maleic acid copolymers, styrene-acrylate copolymers (e.g., styrene-methyl methacrylate copolymers, styrene-ethyl methacrylate copolymers, styrene-butyl methacrylate copolymers, and styrene-phenyl methacrylate copolymers), styrene-methyl α-chloroacrylate copolymers and styrene-acrylonitrile-acrylate copolymers; epoxy resins, polyester resins, polyethylene resins, polypropylene resins, ionomer resins, polyurethane resins, ketone resins, ethylene-ethyl acrylate copolymers, xylene resins, polyamide resins, phenolic resins, polycarbonate resins, and melamine resins.

Suitable coating methods include known coating methods such as spray drying methods, dipping methods, and powder coating methods. It is preferable to use a fluidized bed type coating apparatus because a film having a uniform thickness can be formed. The thickness of the coating film is preferably from 0.02 to 1 μm, and more preferably from 0.03 to 0.8 μm.

The toner constituents such as the binder resin, colorant, wax and internal and external additives contribute to charging of the toner composition. When the toner composition receives stresses in a developing unit, the form of the surface of particles of the toner composition changes. In addition, constitution of the particles of the toner composition also changes. Namely, the charge conditions of the particles of the toner composition which has received stresses are different from the charge conditions of the original particles of the toner composition. Change of charge conditions is macroscopically represented as change of charge quantity.

In order to investigate the charging phenomenon of toners, the present inventors examine the charge conditions of the external additive (i.e., inorganic or organic particulate materials), particularly particulate silica, which is present on the surface of toner particles and which largely contribute to charging of the toner composition, using X-ray photoelectron spectroscopy (XPS). As a result, it is found that the position of the narrow scan peak of Si2p in the original toner composition is different from that of the narrow scan peak of Si2p in the toner composition which is repeatedly used (i.e., a deteriorated toner). In general, the peak of Si2p is observed at 103.5 eV. However, the peak of Si2p for the original toner composition is observed at 104.5 eV. The reason therefor is considered to be that the Si element in the original toner composition is charged up and retains a charge. It is also found that when the toner and a carrier are mixed with a TURBULA mixer for a certain time, such a change of charge properties can be observed.

As a result of the present inventors' investigation, it is found that when the toner satisfies the following relationship:

(PSi2p (1 min)−PSi2p (30 min))≦0.8 eV

wherein PSi2p (1 min) represents the position of the peak of Si2p of the Si element in the toner composition which is mixed with a carrier for 1 minute using a TURBULA mixer, and PSi2p (30 min) represents the position of Si2p of the Si element in the toner composition which is mixed with the carrier for 30 minute using the TURBULA mixer, the object of the present invention can be attained. Thus, the present invention is made.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

At first, the following components were cooled at −20° C. for one hour.

| | |
|---|---|
| Low molecular weight polyester resin | 60 |
| High molecular weight styrene-acrylic resin | 30 |
| Carbon black | 4 |
| Carnauba wax | 4 |
| Charge controlling agent (E-84) | 1 |

Then the mixture was kneaded with a two-axis screw kneader such that the kneaded mixture was continuously extruded by a die without causing pulsating flow. After the kneaded mixture was subjected to roll cooling and crushing, the crushed mixture was pulverized with a jet mill followed by classification using an airflow classifier. Thus, a toner composition having a volume average particle diameter of 5.3 μm, and a number average particle diameter of 4.8 μm was prepared.

Magenta, cyan and yellow color toners were also prepared in the same way except that the pigment was replaced with color pigments.

Then 0.5 parts of titania, and 0.5 parts of zinc stearate were mixed with each of the four color toners for 2 minutes using a Henschel mixer. In this case, mixing energy was applied to the mixture, which had achieved an ordered mixture state, while controlling the mixing energy. Mixing energy can be controlled by controlling the revolution of the agitator used, the form of a spring of the agitator and the form of the container. In addition, in this example, mixing energy was applied to the mixture (i.e., the speed of collision of the external additive with the toner particles was controlled) so that the binder resin in the toner particles had a temperature not less than the phase transition temperature thereof. The volume of the mixer is 100 liters. The revolution of the agitator was 1000 rpm.

Then 1 part of silica was added to the mixture and the mixture was subjected to the same mixing treatment for 1 minute. This mixing treatment was repeated three times. The thus prepared toner composition was transferred to another tank and then fed again to a Henschel mixer to perform the mixing treatment for 1 minute. Thus, 50 kg of a toner could be prepared.

Then 5 parts of the thus prepared toner composition, which had been preserved for 30 days after the preparation thereof, were mixed with 100 parts of a carrier, which had been prepared by spray-coating a silicone resin solution on a magnetite (core material) having a particle diameter of 34 μm to form a silicone resin film of 0.5 μm thick thereon. Thus, a two component developer was prepared.

The thus prepared two component developer was agitated with a TURBULA mixer for 1 minute and 30 minutes, followed by analysis by X-ray photoelectron spectroscopy. In this case, a KRATOS X-ray photoelectron spectroscopy analyzer AXIS-ULTRA from Shimadzu Corp. was used. As a result, the difference between the position of the Si2p peak of surface of the toner which was mixed for 1 minute and that of the toner which was mixed for 30 minutes was 0.6 eV. In addition, the half width of the Si2p peak of surface of the toner which was mixed for 30 minutes is 110% of (i.e., 1.1 times) that of the toner which was mixed for 1 minute.

In addition, it was found by mapping using X-ray photoelectron spectroscopy that the electrons are shared by the external additives and the surface of the toner particles. Further, it was found by TOF-SIMS (Time Of Flight-Secondary Ion Mass Spectrometry) that the thickness of the coating of the carrier is in the specific range of from 75% to 125% of the average thickness (specifically the thickness of the coating fell in a range of from 95% to 105%). In this case, a TOF-SIMS analyzer, TRIFT, from ULVAC-PHI, Inc., was used.

In addition, when the toner was used as a replenishing toner in a color printer IPSIO 8000 manufactured by Ricoh Co., Ltd., the charge quantity of the replenished toner was −18 μc/g which is almost the same as that (−22 μc/g) of the previously existing toner (i.e., the same toner as the replenished toner) before the toners reached the doctor blade of the color printer. The color printer IPSIO 8000 has a developing unit including a toner replenishing section configured to replenish a (new) toner, a mixing section having a two-axis screw configured to mix the replenished toner with a carrier, a developing sleeve configured to adhere the toner to an electrostatic latent image formed on a photoreceptor, and a doctor blade configured to regulate flow of the toner toward the developing sleeve.

Further, when images were formed using the color printer IPSIO 8000, from which an oil coating mechanism had been removed, the fine line images and solid images had good image qualities and background fouling was not observed. The toner transfer rate (a weight ratio of the transferred toner image to the toner image formed on the photoreceptor) was 98%. The two component developer was not replaced with a new one until 250,000 images were produced. The developer had good charge rising property, and therefore background fouling was not produced when high speed copying was performed while the toner was replenished. In addition, even when 150,000 images were further produced (i.e., 400 images in total), background fouling was not observed in the images.

### Example 2

The procedure for preparation of the toner and the developer in Example 1 was repeated except that when the toner composition was prepared, the mixing operation was performed only one time when the silica was added.

As a result of the photoelectron analysis, the difference between the position of the Si2p peak of surface of the toner which was mixed for 1 minute and that of the toner which was mixed for 30 minutes was 0.7 eV. In addition, the half width of the Si2p peak of surface of the toner which was mixed for 30 minutes is 115% of (i.e., 1.15 times) that of the toner which was mixed for 1 minute.

In addition, it was found by mapping using X-ray photoelectron spectroscopy that the electrons are shared by the external additives and the surface of the toner particles. Further, it was found by TOF-SIMS that the thickness of the coating of the carrier is in the specific range of from 75% to 125% of the average thickness (specifically the thickness of the coating fell in a range of from 90% to 110%)

In addition, when the toner was used as a replenishing toner in a color printer IPSIO 8000 manufactured by Ricoh Co., Ltd., the charge quantity of the replenished toner was −17 μc/g which is almost the same as that (−22 μc/g) of the previously existing toner before the toners reached the doctor blade of the color printer.

Further, when images were formed using the color printer IPSIO 8000, from which an oil coating mechanism had been removed, the fine line images and solid images had good image qualities and background fouling was not observed. The toner transfer rate (a weight ratio of the transferred toner image to the toner image formed on the photoreceptor) was 95%. The developer was not replaced with a new one until 200,000 images were produced. The developer had good charge rising property, and therefore background fouling was not produced when high speed copying was performed while the toner was replenished. In addition, even when 100,000 images were further produced (i.e., 300,000 images in total), background fouling was not observed in the images.

### Example 3

The procedure for preparation of the toner and the developer in Example 1 was repeated except that when zinc stearate was not added to the toner particles.

As a result of the photoelectron analysis, the difference between the position of the Si2p peak of surface of the toner which was mixed for 1 minute and that of the toner which was mixed for 30 minutes was 0.7 eV. In addition, the half width of the Si2p peak of surface of the toner which was mixed for 30 minutes is 100% of (i.e., 1.00 time) that of the toner which was mixed for 1 minute.

In addition, it was found by mapping using X-ray photoelectron spectroscopy that the electrons are shared by the external additives and the surface of the toner particles. Further, it was found by TOF-SIMS that the thickness of the coating of the carrier is in the specific range of from 75% to 125% of the average thickness (specifically the thickness of the coating fell in a range of from 82% to 118%).

In addition, when the toner was used as a replenishing toner in a color printer IPSIO 8000 manufactured by Ricoh Co., Ltd., the charge quantity of the replenished toner was −20 μc/g which is almost the same as that (−22 μc/g) of the previously existing toner before the toners reached the doctor blade of the color printer.

Further, when images were formed using the color printer IPSIO 8000, from which an oil coating mechanism had been removed, the fine line images and solid images had good image qualities and background fouling was not observed. The toner transfer rate (a weight ratio of the transferred toner image to the toner image formed on the photoreceptor) was 95%. The developer was not replaced with a new one until 300,000 images were produced. The developer had good charge rising property, and therefore background fouling was not produced when high speed copying was performed while the toner was replenished. In addition, even when 200,000 images were further produced (i.e., 500,000 images in total), background fouling was not observed in the images.

### Comparative Example 1

The procedure for preparation of the toner and the developer in Example 1 was repeated except that the external additives (i.e., titania, zinc stearate, and silica) were added to the toner particles without performing the mixing operations performed in Example 1, and in addition the two component developer was prepared without preserving the toner composition for 30 days.

As a result of the photoelectron analysis, the difference between the position of the Si2p peak of surface of the toner which was mixed for 1 minute and that of the toner which was mixed for 30 minutes was 1.0 eV.

Further, when images were formed using the color printer IPSIO 8000, from which an oil coating mechanism had been removed, the fine line images and solid images had good image qualities. The toner transfer rate (a weight ratio of the transferred toner image to the toner image formed on the photoreceptor) was 83%. The developer had to be replaced with a new one after 50,000 images were produced. The charge rising property is not good, and therefore background fouling was observed from the 5,000^{th} image even under high temperature and high humidity conditions. In addition, background fouling was observed from the 15,000^{th} image under normal conditions.

Thus, the toner and developer of the present invention have good durability, and therefore the amount of a waste carrier can be reduced. In addition, the toner and developer can produce good images without causing a background fouling problem and a toner scattering problem.

This document claims priority and contains subject matter related to Japanese Patent Application No. 2002-194582, filed on Jul. 3, 2002, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner composition comprising:
toner particles; and
an external additive located on the surface of the toner particles and comprising Si,
wherein the toner composition satisfies the following relationship:
(PSi2p (1 min)−PSi2p (30 min))≦0.8 eV
wherein PSi2p (1 min) represents a position of a Si2p peak of the Si element of the toner composition when the toner composition is subjected to an X-ray photoelectron spectroscopy analysis after the toner composition is mixed with a carrier for 1 minute using a TURBULA mixer at a revolution of 20 rpm, and PSi2p (30 min) represents a position of a Si2p peak of the Si element of the toner composition when the toner composition is subjected to the X-ray photoelectron spectroscopy analysis after the toner composition is mixed with the carrier for 30 minute using the TURBULA mixer at a revolution of 2.0 rpm.

2. The toner composition according to claim 1, wherein the Si2p peak at the position PSi2p (30 min) has a half width not less than 1.20 times that of the Si2p peak at the position PSi2p (1 min).

3. The toner composition according to claim 1, wherein electrons are shared by the external additive and the toner particles.

4. The toner composition according to claim 1, wherein when the toner composition is used for a developing device which includes a toner replenishing section configured to replenish the toner composition, a mixing section having a two-axis screw and configured to mix a carrier and the toner composition supplied from the toner replenishing section to prepare a developer, a developing sleeve configured to bear the developer on the surface thereof to adhere the toner composition to an electrostatic latent image on an image bearer, and a regulating member configured to regulate flow of the developer to the developing sleeve, the replenished toner composition has substantially a same charge quantity as that of the toner composition which previously exists in the mixing section when the replenished toner composition and the previously existing toner composition reach the regulating member.

5. The toner composition according to claim 4, wherein the replenished toner composition has a charge quantity not less than 0.7 times that of the previously existing toner composition when the replenished toner composition and the previously existing toner composition reach at least one of the doctor blade and the doctor roller.

6. A two component developer comprising:
a carrier; and
a toner composition comprising:
toner particles; and
an external additive located on the surface of the toner particles and comprising Si,
wherein the toner composition satisfies the following relationship:
(PSi2p (1 min)−PSi2p (30 min))≦0.8 eV
wherein PSi2p (1 min) represents a position of a Si2p peak of the Si element of the toner composition when the toner composition is subjected to an X-ray photoelectron spectroscopy analysis after the toner composition is mixed with a carrier for 1 minute using a TURBULA mixer at a revolution of 20 rpm, and PSi2p (30 min) represents a position of a Si2p peak of the Si element of the toner composition when the toner composition is subjected to the X-ray photoelectron spectroscopy analysis after the toner composition is mixed with the carrier for 30 minute using the TURBULA mixer at a revolution of 20 rpm.

7. The two component developer according to claim 6, wherein the carrier is a carrier coated with a material, and wherein any portions of the material located on the carrier have a thickness in a range of from 75% to 125% of an average thickness thereof.

8. A method for developing an electrostatic latent image, comprising:
replenishing a toner from a replenishing section;
mixing a carrier and the toner in a mixing section having a two-axis screw to prepare a developer,
feeding the developer toward a developing sleeve;
regulating flow of the developer to the developing sleeve with a regulating member; and
developing the electrostatic latent image with the toner in the developer on the developing sleeve,
wherein the toner is the toner composition according to claim 1.

9. The method according to claim 8, wherein the Si2p peak at the position PSi2p (30 min) has a half width not less than 1.20 times that of the Si2p peak at the position PSi2p (1 min).

10. The method according to claim 8, wherein electrons are shared by the external additive and the toner particles.

11. The method according to claim 8, wherein the replenished toner has substantially a same charge quantity as that of the toner which previously exists in the mixing section when the replenished toner and the toner previously existing in the mixing section reach the regulating member.

12. The method according to claim 11, wherein the replenished toner has a charge quantity not less than 0.7 times that of the toner previously existing in the mixing section when the replenished toner and the previously existing toner reach the regulating member.

13. An apparatus for developing an electrostatic latent image, comprising:
a replenishing device configured to replenish a toner;
a mixing device configured to mix a carrier and the toner with a two-axis screw to prepare a developer,
a developing sleeve configured to bear the developer thereon to develop the electrostatic latent image with the toner in the developer; and
a regulating member configured to regulate flow of the developer to the developing sleeve
wherein the toner is the toner composition according to claim 1.

14. The apparatus according to claim 13, wherein the Si2p peak at the position PSi2p (30 min) has a half width not less than 1.20 times that of the Si2p peak at the position PSi2p (1 min).

15. The apparatus according to claim 13, wherein electrons are shared by the external additive and the toner particles.

16. The apparatus according to claim 13, wherein the replenished toner has substantially a same charge quantity as that of the toner which previously exists in the mixing section when the replenished toner and the toner previously existing in the mixing section reach the regulating member.

17. The apparatus according to claim 16, wherein the replenished toner has a charge quantity not less than 0.7 times that of the toner previously existing in the mixing section when the replenished toner and the previously existing toner reach the regulating member.
